(19) United States
(12) Patent Application Publication
(10) Pub. No.: US 2023/0008702 A1
(43) Pub. Date: Jan. 12, 2023

(54) DEVICE AND METHOD FOR DETECTING LEAKAGE OF A HYDRAULIC CYLINDER

(71) Applicant: LIEBHERR-COMPONENTS KIRCHDORF GMBH, Kirchdorf (DE)

(72) Inventors: Michael ÖSTERREICHER, Schechingen (DE); Jürgen BOPP, Ummendorf (DE); Hans-Peter LAVERGNE, Trunkelsberg (DE)

(21) Appl. No.: 17/783,243

(22) PCT Filed: Dec. 9, 2020
(86) PCT No.: PCT/EP2020/085359

§ 371 Date: Jun. 7, 2022

(30) Foreign Application Priority Data
Dec. 9, 2019 (DE) 10 2019 133 491.8

(51) Int. Cl. G01M 3/32; F15B 19/00

(52) U.S. Cl. CPC G01M 3/3272; F15B 19/005; G01M 3/025

(57) ABSTRACT

The present invention relates to a device for detecting leaks in a hydraulic cylinder, comprising: a first pressure sensor for detecting a pressure value in a first pressure chamber of a hydraulic cylinder, a second pressure sensor for detecting a pressure value in a second pressure chamber of the hydraulic cylinder, an evaluation unit for continuously detecting the pressure values of the first pressure sensor and the second pressure sensor, the evaluation unit being designed to detect a leak, preferably an internal leak, in the hydraulic cylinder that deviates from the norm based on the pressure values recorded by the first pressure sensor and the second pressure sensor.

### CROSS-REFERENCE TO RELATED APPLICATIONS

This application is a U.S. national phase entry of, and claims priority to, International Patent Application No. PCT/EP2020/085359 (filed 9 Dec. 2020), which claims priority to German Patent Application No. 102019133491.8 (filed 9 Dec. 2019). The entire subject matter in both of these applications is incorporated herein by reference.

### BACKGROUND

### Technical Field

The present invention relates to a device and a method for leak detection in a hydraulic cylinder, in particular a differential cylinder.

### State of the Art

Hydraulic seals, in particular piston seals, are subject to wear and have to be changed during the lifetime of the hydraulic cylinder. It may furthermore be the case that unforeseeable operating states or contamination contained in the hydraulic fluid lead to premature wear of the piston seal or other seals of the hydraulic cylinder.

Worn or damaged seals result in undesired leakage. In this case, it is in particular difficult to identify damage to the piston seal, because in the case of a differential cylinder the leak caused thereby cannot be identified on the hydraulic cylinder from the outside. Thus, merely a transfer of hydraulic fluid from a hydraulic chamber under high pressure, to the hydraulic chamber under lower pressure, takes place. A disadvantage of this is that stopping the hydraulic cylinder requires a higher pump output, because the hydraulic fluid flowing out on account of the leak has to be pumped back. In the worst case, in addition to the efficiency loss already discussed, total failure of the hydraulic cylinder may occur, which generally causes undesired downtime of the machine provided with the hydraulic cylinder.

The aim of the present invention is accordingly that of identifying leaks, in particular in the case of a piston seal, early on, in particular if these initially cause an unnoticeably small efficiency loss and/or no visible signs of a leak are yet identifiable from the outside.

Information of this kind relating to an impending leak or a very small leak that has already occurred makes it possible to promptly commission maintenance or repair, such that unforeseen downtimes of the machine provided with the hydraulic cylinder no longer occur. Furthermore, the hydraulic cylinder can be serviced in a manner appropriate for operation, since the wear state is detected promptly, such that operating, maintenance and energy costs can be saved.

### BRIEF SUMMARY

The problem discussed above is solved by a device according to claim 1 and/or a method according to claim 8 which has all the features of claim 1.

According to the invention, the device for leak detection in a hydraulic cylinder comprises a first pressure sensor for acquiring a pressure value in a first pressure chamber of a hydraulic cylinder, a second pressure sensor for acquiring a pressure value in a second pressure chamber of the hydraulic cylinder, and an evaluation unit for continuous acquisition of the pressure values of the first pressure sensor and the second pressure sensor, wherein the evaluation unit is configured to identify a leak that deviates from the norm, preferably an internal leak, of the hydraulic cylinder, on the basis of the acquired pressure values of the first pressure sensor and of the second pressure sensor.

According to a development of the invention, the hydraulic cylinder may be a double-acting hydraulic cylinder which comprises a respective pressure sensor provided for each pressure chamber.

The evaluation unit is now capable of analyzing the obtained pressure values of the two pressure sensors that are connected to the two pressure chambers, and assessing these with respect to abnormally high leakage. In this case, both at least one pressure value of the first pressure sensor and at least one pressure value of the second pressure sensor are included in the evaluation.

Accordingly, the evaluation makes it possible to check whether the seal, in particular the piston seal of the hydraulic cylinder, is still functioning or is already admitting a leak.

In this case, the basic concept of the invention is that it is possible to deduce wear of the seal (=leak) for example on the basis of a pressure difference in the pressure values acquired by the two pressure sensors. This approach, specifically observing the two pressure values of the pressure sensors in the different chambers of the hydraulic cylinder, is not known from the prior art.

According to an optional modification of the invention, it can furthermore be provided for the evaluation unit for evaluating the acquired pressure values of the first pressure sensor and of the second pressure sensor to use a neural network or to be a neural network. The advantage of this is that, in the case of corresponding training data, a neural network develops its own criteria or classification parameters, on the basis of which it identifies whether or not a hydraulic cylinder has a leak. Of course it is also possible, however, to give guidelines, on the basis of which the neural network should make decisions.

According to the invention, it can furthermore be provided for the evaluation unit to be configured to classify combinations of pressure values of the first pressure sensor and of the second pressure sensor as being within the norm or outside of the norm, by means of machine learning.

In this case, the evaluation of the acquired pressure values can be performed during the ongoing operation of the hydraulic cylinder, such that continuous monitoring of the hydraulic cylinder also takes place during operation.

The evaluation unit may be configured to form the classification parameters for identifying a leak of the hydraulic cylinder which deviates from the norm, by means of unsupervised machine learning.

In the case of the machine learning method of unsupervised learning, the grouping of data is at the forefront. This is usually based on statistical methods, such that dependencies in the supplied data can be identified. Thus, specific values of pressure value combinations of the two pressure sensors, or of sequences thereof, are associated with normal operation of the hydraulic cylinder or with a state deviating from the norm. Furthermore, anomaly identification is possible, determined by appropriate formation of clusters (classification parameters), which correspond to datasets of the norm and which are more noticeable. In this case, the evaluation is preferably also based on rules and connections created by the machine. It is thus possible for a leaky piston in the hydraulic cylinder to be identified early.

In this case it may be provided for measuring data of the first pressure sensor and of the second pressure sensor of a faulty hydraulic cylinder, and corresponding measuring data of a non-faulty hydraulic cylinder, to be consulted for training the unsupervised machine learning.

In this case it may furthermore be provided that, after training of the unsupervised machine learning, the evaluation unit is configured to subject a combination of pressure values of the two pressure sensors to a plausibility check, which is based on the principle of supervised learning.

The invention further relates to a method for leak detection in a hydraulic cylinder, wherein, in the method, pressure values of a first pressure sensor, which measures the pressure in a first chamber of a hydraulic cylinder, and pressure values of a second pressure sensor, which measures the pressure in a second chamber of the hydraulic cylinder, are recorded continuously, and a leak that deviates from the norm, preferably an internal leak, is deduced on the basis of the acquired pressure values.

In the case of a hydraulic cylinder, an internal leak is a flow of hydraulic cylinder beyond the piston, from one pressure chamber to the other pressure chamber. A flow of this kind is prevented by an intact piston seal.

According to the method, it may be provided for the deviation from the norm to be achieved by classification of pressure values of the two chambers, measured at the same time, or a series of pressure values of the two chambers, measured at the same time.

The data measured by the pressure sensors at one timepoint form a dataset or a part of a dataset, which is checked for abnormalities by the evaluation unit. In this case, the dataset can for example also be associated with a state of travel of the piston, such that a movement deviation of the piston in the case of unremarkable pressure values is also identified.

In this case, the datasets created can also represent datasets of a certain temporal progression, such that the evaluation does not have to be limited to a particular timepoint, and conditions that vary over time are also visible.

According to the method according to the invention, it may be provided for machine learning, in particular unsupervised machine learning, to be used for assessing whether there is a deviation from the norm, preferably in that measuring data of the first pressure sensor and of the second pressure sensor of a faulty hydraulic cylinder, and measuring data of the first pressure sensor and of the second pressure sensor of a non-faulty hydraulic cylinder, to be consulted for a training sequence of the unsupervised machine learning.

The particularity of unsupervised learning is that the expected output is not known at the start of the learning process. Although datasets of a faulty hydraulic cylinder and of an intact hydraulic cylinder are supplied, during unsupervised learning, the categories (for example piston seal intact or not intact) into which the evaluated data are to be divided are not specified. The approached in the case of unsupervised machine learning is unbiased as to the result. The learning process takes place in that the algorithm attempts to duster, i.e. to group, data in a particular manner, or to identify anomalies.

Furthermore, according to a development of the invention it may be provided for the output of the assessment of whether there is a deviation from the norm, which output is obtained on account of unsupervised machine learning, is used as training data for supervised learning, in order to verify whether the assumptions used for the supervised learning are correct.

Thus, the datasets obtained by the unsupervised learning are used as labeled datasets, and as training data for subsequent supervised learning. This results in a model which can be tested using the labeled data.

According to an optional modification of the invention, it may be provided for the evaluation of whether a leak deviating from the norm is present to be performed during the operation of the hydraulic cylinder.

It can furthermore be provided for the evaluation of whether a leak deviating from the norm is present to be achieved by the classification of pressure values of the two chambers that are measured at the same time, or a temporal sequence of pressure values of the two chambers measured at the same time.

It is also possible for not only the pressure values of the two pressure sensors, but rather also the state of travel of the hydraulic cylinder, to be consulted in order to evaluate whether a leak deviating from the norm is present.

In this case, a pressure value of the first pressure sensor, a pressure value of the second pressure sensor, and the state of travel of the hydraulic cylinder, for a common timepoint, can form a dataset, and the evaluation of whether a leak deviating from the norm is present can take place on the basis of said dataset or a temporal sequence of a plurality of said datasets.

According to a further optional modification of the present invention it may be provided for the first pressure sensor and/or the second pressure sensor to be arranged directly in the hydraulic cylinder or integrated therein.

This arrangement position allows for the acquisition of the substantially higher damping pressures, which is advantageous because in this case there is as high a pressure difference as possible between the two pressure sensors, such that it is possible to perform particularly accurate evaluation with respect to a leak. A further advantage of an arrangement directly in the cylinder is that in this case the substantially higher damping pressures can be acquired.

However, according to a further development of the invention it can be provided for the first pressure sensor and/or the second pressure sensor to be arranged at the cylinder connections of the hydraulic cylinder, or even on an upstream control block, in order to thereby deduce the pressure ratios in the interior of the hydraulic cylinder. In this arrangement position, too, acquisition of the pressure by means of the first pressure sensor and/or the second pressure sensor makes it possible to deduce a leak of the piston seal. An arrangement position of this kind lends itself for example if the hydraulic cylinder does not have any mechanical damping.

According to an advantageous variant of the present invention, the hydraulic cylinder has mechanical damping.

Furthermore, according to a further advantageous variant of the present invention, it may be provided for the foreign unit to be an engine control unit, to be implemented in an engine control unit of this kind, or to be based on an engine control unit.

An advantage of an integration of the evaluation unit in an engine control unit is that an engine control unit of this kind is already present in a construction vehicle, which bears a hydraulic cylinder provided with the leak detection means, such that additional hardware is no longer required.

### BRIEF DESCRIPTION OF THE DRAWINGS

Further features, details and advantages of the invention are evident from the following description of the drawings, in which:

FIG. 1: is a schematic view of the device according to the invention on a hydraulic cylinder, and

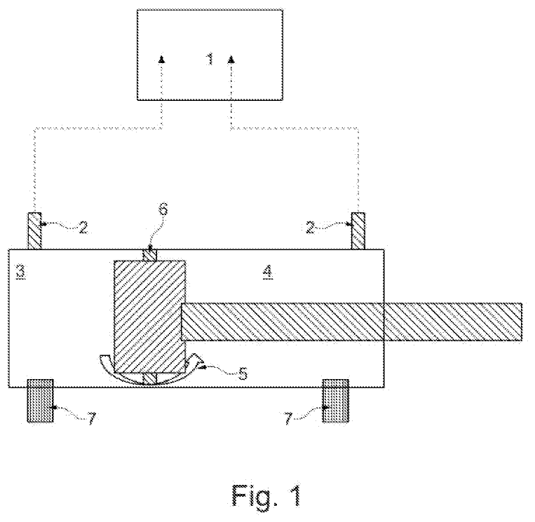

FIG. 2: is a flow diagram for the method for leak detection. FIG. 1 is a schematic view of a differential cylinder which is divided, by a piston, into a first pressure chamber 3 and a second pressure chamber 4. In this case, the piston comprises a seal 6, such that the two pressure chambers are fluidically separated from one another. If the piston is moved, this is achieved by the supply and corresponding discharge of a hydraulic fluid via the two fluid connections 7.

### DETAILED DESCRIPTION

However, if the seal 6 is faulty or already worn beyond the allowable extent, a leak 5 occurs, such that hydraulic fluid flows from a chamber 3 that is under a high pressure to a chamber 4 that is under a lower pressure.

Since a leak of this kind is not visible from the outside, but leads to increased pumping effort for the hydraulic fluid, and at worst can even lead to damage to the hydraulic cylinder, it is advantageous to promptly identify this leak state.

For this purpose, one pressure sensor 2, in each case, is provided on each of the two pressure chambers 3, 4, in order to transmit pressure values to an arithmetic unit 1. An evaluation then takes place in said arithmetic unit, which evaluation can identify a leak between the two chambers, beyond the piston, on the basis of the identified pressure values of the two pressure chambers. In this case, the piston seal is typically worn, such that there is a fluid passage between the two pressure chambers which are actually separated by the piston.

In this case, the pressure states, which clearly identify the leak state of the hydraulic cylinder, are classified in the arithmetic unit by means of machine learning. During the operation of the hydraulic cylinder, the pressure signals from the two chambers are evaluated, and the operating state of the piston seal is deduced.

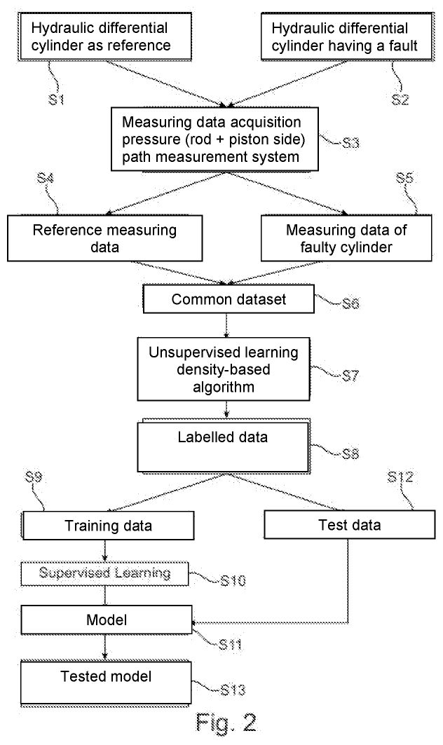

In this case, the evaluation is explained on the basis of a flow chart, which is shown in FIG. 2.

S1 and S2 specify that both a completely intact hydraulic cylinder as a reference, and a faulty hydraulic cylinder comprising a worn piston seal, are required, in order to generate corresponding measuring data of the two hydraulic cylinders in S3. Thus, in S3, the pressure of a differential cylinder is acquired on the rod side and the piston side. In this case, the acquisition can take place over a specified travel path at different compressive loads of the cylinder, and can furthermore also draw on values from the path measurement system of the hydraulic cylinder.

After the measuring data from the intact hydraulic cylinder have been complied, these form reference measuring data (S4). Analogously thereto, the measuring data of the faulty hydraulic cylinder form measuring data of the faulty cylinder (S5).

In S6, the measuring data of the intact and of the faulty hydraulic cylinder are combined to form a common dataset, in order to be used as a basis for unsupervised machine learning. In this case, in the present case it is advantageous for the underlying duster method to be a density-based method, which draws on algorithms for data density and distance functions.

The labeled data (S8), which are used in S9 as training data for supervised machine learning (S10), are then obtained therefrom.

The neural network, thus trained, forms, on the basis thereof, a model (S11) which can be tested using test data (S12) which are obtained from the labeled data (S8), such that a tested model (S13) is obtained as a result.

This tested model (S13) is applied by the arithmetic unit 1 such that, in the case of corresponding pressure values of the two pressure sensors, it is possible to reliably deduce a fault in the piston seal. For this purpose, the generated pressure values are simply continuously forwarded to the arithmetic unit 1, which can identify, on the basis of the tested model, the presence of a leak which deviates from the norm and which may be caused by a faulty piston seat.

1. A device for leak detection in a hydraulic cylinder, the device comprising:
a first pressure sensor for acquiring a first pressure value in a first pressure chamber of a hydraulic cylinder;
a second pressure sensor for acquiring a second pressure value in a second pressure chamber of the hydraulic cylinder; and
an evaluation unit for repeated acquisition of the first and second pressure values of the first pressure sensor and the second pressure sensor, wherein the evaluation unit is configured to identify a leak of the hydraulic cylinder that deviates from a norm based on the first and second pressure values that were acquired from the first pressure sensor and the second pressure sensor.

2. The device according to claim 1, wherein the evaluation unit for evaluating the first and second pressure values that were acquired from the first pressure sensor and the second pressure sensor uses a neural network or is a neural network.

3. The device according to claim 1, wherein the evaluation unit is configured to classify combinations of the first and second pressure values from the first pressure sensor and the second pressure sensor as being within the norm or outside of the norm using machine learning.

4. The device according to claim 1, wherein the evaluation unit is configured to perform evaluation of the first and second pressure values during ongoing operation of the hydraulic cylinder.

5. The device according to claim 1, wherein the evaluation unit is configured to form classification parameters for identifying the leak of the hydraulic cylinder which deviates from the norm using unsupervised machine learning.

6. The device according to claim 5, wherein the evaluation unit is configured to be trained using the unsupervised machine learning using data of the first pressure sensor and the second pressure sensor for a faulty hydraulic cylinder and using data of a non-faulty hydraulic cylinder.

7. The device according to claim 5, wherein the evaluation unit is configured to subject a combination of the first and second pressure values of the first and second pressure sensors to a plausibility check based on a principle of supervised learning after training using the unsupervised machine learning.

8. A method for leak detection in a hydraulic cylinder, the method comprising:
repeatedly obtaining first pressure values from a first pressure sensor that measures first pressure in a first chamber of the hydraulic cylinder and second pressure values from a second pressure sensor that measures second pressure in a second chamber of the hydraulic cylinder; and
identifying a leak that deviates from a norm based on the first and second pressure values that are obtained.

9. The method according to claim 8, wherein the leak is identified by classification of the first and second pressure values of the first and second chambers measured at a same time or a series of the first and second pressure values of the first and second chambers measured at the same time.

10. The method according to claim 8, wherein machine learning is used for identifying the leak.

11. The method according to claim 10, further comprising:
assessing whether there is a deviation from the norm; and
using output obtained on account of machine learning as training data for supervised learning to verify whether assumptions used for the supervised learning are correct.

12. The method according to claim 8, wherein the leak is identified during operation of the hydraulic cylinder.

13. The method according to claim 8, wherein identification of the leak is achieved by classifying the first and second pressure values of the first and second chambers measured at a same time or a temporal sequence of the first and second pressure values of the first and second chambers measured at the same time.

14. The method according to claim 8, wherein the leak is identified also using a state of travel of the hydraulic cylinder.

15. The method according to claim 14, wherein the first pressure value of the first pressure sensor, the second pressure value of the second pressure sensor, and the state of travel of the hydraulic cylinder for a common timepoint form a dataset, and identification of the leak is based on the dataset or a temporal sequence of a plurality of the datasets.

16. The device according to claim 1, wherein the evaluation unit is configured to identify the leak as an internal leak of the hydraulic cylinder.

17. The device according to claim 1, wherein the first pressure sensor is configured to continuously measure the first pressures and the second pressure sensor is configured to continuously measure the second pressures.

18. The method according to claim 8, wherein the leak is identified as an internal leak of the hydraulic cylinder.

19. The method according to claim 10, wherein the machine learning identifies the leak using the first and second pressures measured by the first and second pressure sensors for a faulty hydraulic cylinder and using the first and second pressures measured by the first and second pressure sensors for a non-faulty hydraulic cylinder.

20. The method according to claim 8, wherein the first pressures are continuously measured and the second pressures are continuously measured.
